(19) United States
(12) Patent Application Publication
(10) Pub. No.: US 2018/0060279 A1
(43) Pub. Date: Mar. 1, 2018

(54) SYSTEM AND METHOD FOR CREATING A METROLOGICAL/PSYCHOMETRIC INSTRUMENT

(71) Applicant: LEADERAMP, INC., Vacaville, CA (US)

(72) Inventor: Matthew Frank Barney, Vacaville, CA (US)

(21) Appl. No.: 15/249,412

(22) Filed: Aug. 28, 2016

(51) Int. Cl. G06F 17/18; G06F 17/50

(52) U.S. Cl. CPC G06F 17/18; G06F 17/5009

(57) ABSTRACT

A multidisciplinary approach to constructing qualitatively meaningful metrological instruments is envisioned. Pre-calibrated ‘gold standard’ data item banks, which are constructed in adherence with Rasch quality control parameters, are used as a foundation for the analysis of a plurality of qualitatively different data item types measuring a particular underlying psychological construct. Hypothesized raw data are analyzed in the same frame of reference as that of the ‘gold standard’ data item banks. The ‘gold standard’ data item banks are calibrated using Rasch quality control standards including inlier weighted fit statistics, outlier weighted fit statistics and point measure correlations. By analyzing the raw data under the same frame of reference as that of the ‘gold standard’ data item banks, a metrological instrument that estimates at least one underlying unidimensional construct is constructed.

### TECHNICAL FIELD

The present disclosure relates to transdisciplinary metrology and psychometrics. Particularly, the present disclosure relates to creation and selective calibration of metrological instruments/measurements. The present disclosure also relates to selective calibration of metrological instruments using a many facet model.

### BACKGROUND

With the advent of big data, several technological domains including information technology and statistical analysis have undergone a drastic transformation in terms of how data are gathered and analyzed both qualitatively and quantitatively, inter-alia. With the availability of large amounts of data, attempts are being made to substantially improve the accuracy and precision associated with behavioral more analysis, specifically human behavior modeling, and tracking and monitoring using unobtrusive methodologies, and user latent trait assessment based on (corresponding) social media footprints and electronic device usage. With the availability of large volumes of data and with the availability of computation prowess for methodically analyzing large volumes of data, the emphasis has been shifted from data gathering to scientific processing and analysis of data, and generating actionable insights therefrom. The focus has shifted from the task gathering large volumes of data (incorporating all the parameters considered necessary for an efficient and effective analysis) in view of the availability of computational power to gather large volumes of data under relatively faster time intervals, to the task of developing a meaningful and comprehensive analytical engine that would analyze the voluminous data and elicit meaningful and insightful information therefrom, which would later be studied analyzed to identify and understand the underlying latent attributes.

However, it is also been evident that the raw data gathered using ‘big data technologies’ alone are not entirely sufficient in creating measurements, given the fact that the raw data gathered using ‘big data technologies’ has been historically rendered an ineffective input to producing scientific and meaningful information, sand therefore emphasizing on the need for a mechanism that would segregate the data in a meaningful and scientific manner thereby rendering them suitable for use in advanced metrological instruments and psychometric methods which are designed and calibrated to generate actionable information. Most of the well known models and procedures which embodied usage of raw data in metrological instruments suffered from drawbacks such as presence of dirty/unusable data, inaccurate measurements, lumpy ratings, lack of precision, and the presence of irregular intervals, inter-alia.

In order to address at least some of the disadvantages outlined above, a comparatively sophisticated Rasch model was proposed and successfully implemented. However, while the Rasch family of models perform well in sample-independent measurements, the prior-art technological implementations are inadequate for producing measures from a plurality of raw data types that go beyond a single scientific discipline (e.g. chemical, biological, electrical, informational, psychological, physiological). Prior art attempts at combining these diverse raw data types into a single metrologically meaningful instrument have fallen short in accuracy, precision, and repeatability. Similarly prior art methods such as Item Response Theory and Classical Test Theory fall even further from the measurement requirements of objectivity, accuracy and precision that are intrinsic to the Rasch family of models. Therefore, in view of the deficiencies associated with prior-art technologies and methods in handling transdiscipliary combination of raw data types, a combination of multiple metrological methods and multiple data measurements were proposed as a viable alternative.

Despite the developments discussed hitherto, a model configured for analysis of transdisciplinary combinations of raw data types, could not be sufficiently addressed and remained a compelling need. Several prior attempts were made via the systems/methods proposed by the below mentioned patent documents to provide a model capable of analyzing transdisciplinary combination of raw data types. One such attempt includes a co-pending Patent Application Publication US2015/0112766 filed by the same inventor, which proposes automating, traditional Rasch measurement psychometrics, and mass personalizing the traditional Rasch measurement psychometrics via an obtrusive approach. However, the system/method envisaged by this patent application is not suitable for unobtrusive measurement and calibration of a plurality of diverse raw data types.

Further, US Patent Application Publication 2013/0291092 outlines a psychometric and metrological method applicable specifically for (information) security situations involving passwords. However, this patent application fails to address an interdisciplinary expert system that can implement data calibration in both information security related scenarios as well as non-security related scenarios.

Further, US Patent Application Publication 2012/0330869 presents a system that measures a plurality of data types using artificial intelligence. However, this patent application does not evaluate each raw data type and discards them if they would compromise the metrological requirements for accuracy, precision and/or reliability. Further, this patent application also does not teach artificial intelligent raters for effectively and efficiently rating certain important raw data types appreciated by those knowledgeable in the prior art (e.g. natural language).

US Patent Application Publication 2007/0218450 presents a system that is specifically designed for essay scoring. Further, this patent application also uses a human scorer in the event the essay scoring algorithm fails. However, this Patent Application does not advocate utilizing assessment types and raw data types other than the ones compliant with the requirements of objective measurement. Further, this Patent Application also does not invent any measurement methods that blend artificially intelligent raters and human raters. US Patent Application Publication 2015/0161903 discloses a crowd sourced examination marking procedure which makes use of human raters. However, this Patent Application does not disclose using artificially intelligent raters as a replacement to human raters.

Additionally, most of the conventional data models that attempt the state-of-art metrology are either context-specific (in terms of the data measured and in terms of the data types operated upon) or obtrusive or both. Further, some of the data assessment models are specific to correlations and statistical probabilities which frequently do not render insightful metrological measurements. Further, most of the conventional technologies for measurement neither ensure that the measured data types adhere to certain predetermined metrological quality standards and that the measure dents are effectively traced back to the latent traits specified by the measured data types, nor do they improve the measurements corresponding to the data types so as to render them compliant with metrological quality standards. Further, none of the conventional data assessment models are configured to handle metrological information using multiple variables types that are qualitatively different from each other, but represent the same latent attribute. Instead, the conventional human measurement approaches are either Single Attempt Multiple Item (SAMI) type models or Multiple Attempt Single Item (MASI) type models. One of the major limitations associated with the conventional models is that none can be combined to form a hybrid model that could simultaneously incorporate SAMI variables as well as MASI variables. The aforementioned limitation warrants a compelling solution given the fact that most of the data elements classified as derived from well known ‘big data’ technologies are classified in time series as MASI variables. Further, given the vide spread presence of ‘big data’ technologies and the metrological significance of ‘human data’ which are typically classified under SAMI variables, there is a need for a hybrid model that incorporates SAMI as well as MASI variables and generate unified metrological information. Further, there was also need for an assessment model that synthesizes diverse sets of raw data items, and subsequently converts the synthesized raw data items into unified and insightful metrological information.

### Objects

An object of the present disclosure is to create entirely unobtrusive assessments without any effort on the part of the user, by leveraging passively collected raw data in a metrologically and psychometrically meaningful manner.

Yet another object of the present disclosure is to optimize the utilization of computer power and resources during data gathering and subsequent data analysis.

Still a further object of the present disclosure is to convert the raw data into information using scoring rubrics that have been established as being scientifically relevant.

One more object of the present disclosure is to report the measurements using multiple reporting modalities including graphical reporting, fuzzy-logic based reporting, and psychometrically calibrated coaching.

Yet another object of the present disclosure is to seamlessly track user behavior across a plurality of diversified digital avenues containing information about user behavior and performance, and subsequently provide relevant feed back to the user.

Still a further object of the present disclosure is to connect the qualitative meaning of the data items with the quantitative values, thereby ensuring metrological/psychological and theoretical traceability.

Yet another object of the present disclosure is to create a pre-calibrated data item bank incorporating metrologically relevant data types, and analyze the hypothetical and exploratory raw data using the same set of reference as that of the pre-calibrated data item bank.

One more object of the present disclosure is to determine whether any available raw data types are consistent with the metrologically relevant data types, when processed under a common metrological frame of reference.

### SUMMARY

The present disclosure envisages a multidisciplinary approach to constructing qualitatively meaningful metrological instruments. The present disclosure envisages utilizing pre-calibrated ‘gold standard’ data item banks, which are constructed in adherence with Rasch quality control parameters, as a foundation for the analysis of a plurality of qualitatively different data item types measuring a particular underlying human construct (e.g. psychological, medical). The present disclosure analyzes the hypothesized raw data in the same frame of reference as that of the ‘gold standard’ data item banks. The ‘gold standard’ data item banks are preferably calibrated using Rasch quality control standards including but not restricted to inlier weighted fit statistics, outlier weighted fit statistics and point measure correlations. By analyzing the raw data under the same frame of reference as that of the ‘gold standard’ data item banks, the present disclosure envisages creating a useful metrological instrument that estimates at least one underlying unidimensional construct. The present disclosure envisages combining a plurality of raw data types and metadata types into meaningful metrological information. The present disclosure envisages Multiple Attempt Single Item (MASI) type data variables (which typically characterize ‘big data’ elements) and Single Attempt Multiple Item (SAMI) type data variables (which typically characterize human behavioral data; to be used in combination in a single measurement instrument and under a common metrological frame of reference. Further, the present disclosure envisages transforming the raw data into measurements by comparing them with predetermined objective measurement requirements preferably Rasch quality control parameters) to identify metrologically meaningful information. The method envisioned by the present disclosure generates a plurality of data sets from which a data set best suited for the construction of a measure could be selected. Subsequently, the data sets are further processed using a plurality of metrological models (for example, the Rasch family of models). The present disclosure also envisions evaluating each of the said data sets for adherence to predetermined quality control parameters (for example, Rasch quality control parameters), by iteratively setting target values and tolerance values for each of the quality control parameters. Subsequently, each of the data sets' fit to the corresponding metrological model is determined and the datasets are preferably sorted using a multivariate/univariate quality control procedure, with the data set having the best fit listed at the top of the sorting order and the data set having the worst fit listed at the bottom of the sorting order.

### BRIEF DESCRIPTION OF THE ACCOMPANYING DRAWINGS

FIG. 1 is a flowchart illustrating the steps involved in the method for creating a measurement instrument; and

FIG. 2A and FIG. 2B in combination form a flowchart illustrating the steps involved in constructing new construct segment testlets.

### DETAILED DESCRIPTION

In order to overcome the drawbacks associated with the conventional data assessment models, the present disclosure envisages a multidisciplinary approach to constructing metrological instruments that adhere to an underlying qualitative framework whilst providing insightful, metrology based feedback.

Rasch analysis which is a mathematical modeling approach based upon a latent trait and accomplishes stochastic (probabilistic) conjoint additivity (conjoint denotes measurement of persons and items on the same scale, and additivity is the equal-interval property of the scale) remains one of the most preferred calibration techniques for creating metrological instruments that are useful in a plurality of human sciences such as psychology, and medicine. Construct maps divide the complex levels of peoples' attributes into quantitatively distinguishable levels. Thus, a learning progression could be visualized as a single construct map, or composed of several related construct maps each representing a big idea or practice. The preferred embodiment uses construct maps to draft a prospective psychometric instrument, the underlying hypothesized items are theoretically linked to a latent trait of interest, and positioned in continuum. The apriori hope of scientists is that they will sufficiently approximate the Rasch model, such that their ‘log odds unit estimates’ (Logit) are sufficiently linear, accurate and precise. Typically, a ‘Logit’ is a measurement unit of an underlying and invisible variable, for example, ‘Ampere’ of invisible ‘electric current’. Each item used in Rasch analysis is associated with a hypothezised quantitative value indicative of qualitative meaning, of the underlying latent trait the scientist intends to measure. Therefore, the data items used in Rasch analysis are always construed to be accurate, and sufficiently precise so as to be objective. Further, during Rasch analysis, each of the raw items are subjected to a plurality of quality control parameters including but not restricted to inlier-weighted misfit Unfit), and outlier weighted misfit (Outfit), and point-measure expectations so that each is formally evaluated for sufficient fit to the requirements of the Rasch model. Consequently, the preferred embodiment of the current invention is the use of a Rasch-calibrated, gold-standard,item bank incorporating an item bank that has been established to meet the metrological requirements for scientific instrumentation.

In accordance with the present disclosure, the term ‘gold standard’ used in the context of data items denotes those data items that have been construed to incorporate quantitative data values that the Rasch analysis requires to achieve an objective metrological measurement. Further, the term ‘gold standard’ also indicates that the corresponding data items have been determined as satisfying predetermined quality parameters typically warranted for participation in Rasch analysis.

TABLE 1
Preferred Rasch Quality Control Parameters and Tolerance Values

| | | Default Lower | |
|---|---|---|---|
| | | Specification | Default Upper |
| | | Limit | Specification Limit |
| Quality Parameter | Target | (LSL) | (USL) |
| Inlier weighted | 1.0 | 0.5 | 1.5 |
| Fit | | | |
| Outlier weighted | 1.0 | 0.5 | 1.5 |
| Fit | | | |
| Actual Point | Expected Point | +0.1 | 1.0 |
| Measure | Measure | | |
| Correlation | Correlation | | |

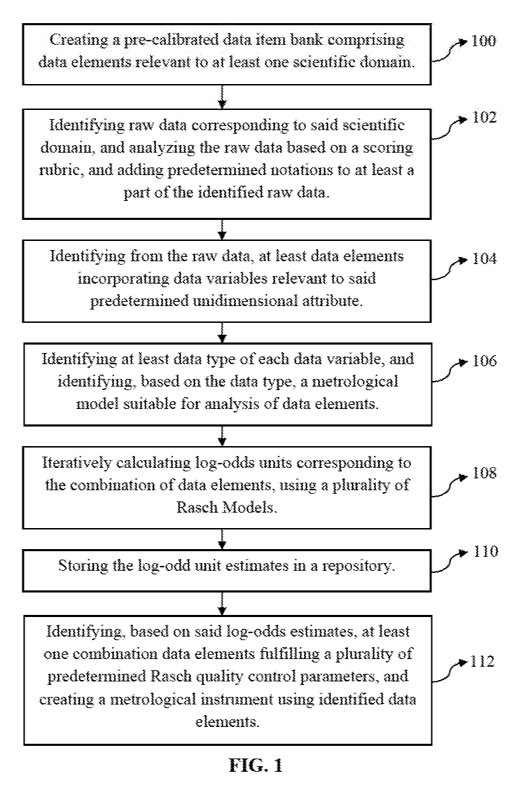

The present disclosure, in FIG. 1, step 100, envisions creating such a pre-calibrated data item bank measuring at least one latent trait corresponding to at least one psychometric domain. These items are construed to adhere to a ‘gold standard’ because there are a plurality of items in the bank that closely meet the quality standards for a Rasch measurement, such as those shown in Table 1. Therefore, at step 100, a pre-calibrated, ‘gold standard’ data item bank incorporating data elements corresponding to at least one predetermined metrological domain is constructed.

In accordance with the present disclosure, at step 102, (exploratory and hypothetical) raw data which correspond to the same scientific domain as that of the data elements constituting the ‘gold standard’ data item bank, is identified. Preferably, to achieve objective measurement, it is imperative that the data elements used in the metrological analysis adhere to certain predetermined benchmarks (in the preferred embodiment, the Rasch quality control parameters listed in Table 1). In addition to the standards in Table 1, the preferred embodiment establishes gold standard item banks that load strongly into one and not more factors, as evidenced by Principle Components statistical analysis known to those expert in the prior art. Since the data elements constituting the ‘gold standard’ data item bank are denoted as confirming to the Rasch quality control parameters standards, it is imperative that any available raw data are compared with the data elements in the ‘gold standard’ data item bank to ensure that metrological analyses are performed using a combination of the raw data and the data elements (constituting the ‘gold standard’ data item bank) and do not deviate significantly from the Rasch quality control standards.

Subsequently, at step 102, the raw data are preferably extracted from a plurality of predetermined sources (for example, gyrometer readings, accelerometer readings, Internet of Things (IOT) data, smart phone contact list, or twitter feeds). Preferably, the raw data are selected for extraction via a Graphical User Interface accessible to a user (for example, an analyst). Preferably, extracted raw data correspond to the same scientific domain as that of the data elements constituting the ‘gold standard’ data item bank. However, any, extracted raw data are rejected that fail to conform to Rasch quality control parameters standards (Table 1 and Principle Component analyses) that ensure creation of an accurate, insightful metrological measurement (instrument).

Further, at step 102, the extracted raw data are processed in accordance with at least one scoring rubric. Preferably, the scoring rubrics include, but are not restricted to, differing levels of data aggregation, and the apriori expected raw data distributions. In accordance with the present disclosure, subsequent to the raw data being extracted from a plurality of predetermined data sources a first scoring rubric implying a level of data aggregation is applied on extracted raw data. For example, millisecond sampling of raw data might not be appropriate as it could be too fine grained, while annualaggregation of the same exact raw dataset may be too coarse. In view of the above mentioned scenario, an analyst is allowed to select at least one appropriate data resolution depending upon at least the same scientific domain of the raw data. However, it is also possible that one than one data resolution is selected for a particular raw data set, and in such an event, raw data sets with different data resolutions are considered as though they are mutually different data sets. For example, if two data resolutions, namely ‘milliseconds’ and ‘microseconds’ are selected for a particular raw data set, then the raw data set with ‘millisecond’ resolution is considered as being different from the raw data set having the ‘microsecond’ resolution. Subsequently, a second scoring rubric, a data distribution framework that the extracted (raw) data is anticipated to follow, is applied to the extracted raw data. For example, the extracted raw data could be designated to follow a Gaussian distribution having four moments, namely, location (for example, menu), spread (for example, standard deviation), skewness and kurtosis. Preferably, the raw data is categorized across all the moments corresponding to the selected distribution framework.

TABLE 2
Examples for Data Resolutions

| | Time | Financial Status | Accelerometer |
|---|---|---|---|
| Micro | millisecond | Annual income for | Mean/SD/Kurtosis/ |
| | | household head | Skewness (four |
| | | | moments) per |
| | | | millisecond |
| | second | Annual Family Income | Four Moments per |
| | | | Second |
| | hour | Annual Neighborhood | Four Moments per Hour |
| | | Income | |
| Meso | day | Annual City GDP | Four Moments per Day |
| | week | Annual State GDP | Four Moments per Week |
| Macro | year | Annual Country GDP | Four Moments per Year |
| | decade | Annual State GDP | Four Moments per |
| | | | Decade |

Further at step 102, the raw data processed using the scoring rubrics is supplemented with appropriate notations/tags for every level of analysis. In this case, preferably, the first level of data analysis is performed in accordance with the first scoring rubric, and the second level of data analysis is performed in accordance with the second scoring rubric. In accordance with the present disclosure, the notations tags are typically considered as an additional scoring rubric. For example, while segregating listeners who skipped from a particular audio recording to another, emphasis is provided to whether the audio recording was skipped right at the beginning thereof or towards the end, and accordingly the raw data indicative of the users who skipped the audio recording is appropriately tagged. Preferably, the listeners who skipped the audio recording at the beginning thereof, and the listeners who skipped the audio recording towards the end thereof are differently tagged, based on the notion that the listeners who skipped the audio recording at the beginning would dislike the audio recording more strongly than the ones who skipped it (audio recording) at the end.

In the manner described above, the extracted raw data are analyzed together, preferably using a technique known in the prior art as Bayesian Joint Maximum Likelihood Estimation, across multiple configurations, thereby exponentially increasing the possibility of one of the scoring rubrics remaining complaint with Rasch quality control parameters standards and also with the benchmarks associated with an objective and insightful metrological procedure/system. Further, the ‘data elements’ constituting the pre-calibrated, ‘gold standard’ data item bank, and the extracted raw data are analyzed using a common reference framework, which is the Rasch quality control parameters standards, in order to ensure that the raw data is as accurate and insightful as the ‘data elements’ constituting the pre-calibrated, ‘gold standard’ data item bank.

In accordance with the present disclosure, the data aggregation level (the first scoring rubric) and the data distribution (second scoring rubric) corresponding to the extracted raw data is preferably displayed on a Graphical User Interface (GUI), thereby providing analysts having access to the GUI, an opportunity to add one or more additional scoring rubrics (for example, a different data aggregation standard or a different data distribution), and also to selectively adjust the existing data aggregation standard and the data distribution, so as to ensure that the extracted raw data conforms the Rasch quality control parameters standards. The existing data aggregation level and the existing data distribution (corresponding to the extracted raw data) are automatically (in a computerized manner) compared with an ideal data aggregation level and an ideal data distribution conforming the Rasch quality control parameters standards, and any deviations of the existing data aggregation level and the existing data distribution from the ideal data aggregation level and ideal data distribution are displayed on the GUI, thereby enabling analysts to selectively adjust the scoring rubrics and also selectively add any additional appropriate scoring rubrics for analysis of extracted raw data.

At step 104, from the (processed) raw data, the data elements metrologically relevant to the data items constituting the ‘gold standard’ data item bank are identified. Preferably, the data elements of the raw data which correspond to the same metrological domain as that of the data items constituting the ‘gold standard’ data item bank are identified as being relevant, and are subsequently extracted for further analysis.

At step 106, the data types of the data elements corresponding to the extracted (processed) raw data, and the data types corresponding to the data elements constituting the ‘gold-standard’ data item bank are individually determined. A plurality of data types including but not restricted to obtrusive and non-obtrusive raw data from natural language, genomics, eye tracking, engineering hardware software modules (for example, accelerometers), meta data (for example, call log units) can be considered.

Preferably, all the identified data types are aggregated into a Partial Credit Model (PCM) framework. Further, at step 106, for every level of data aggregation (as explained in step 102, it is evident that there exists at least one data aggregation level), the identified data types are categorized based on the underlying Multiple Attempt Single Item (MASI) variables. In this exemplary embodiment, since the data types corresponding to the all the MASI variables are aggregated into the Partial Credit Model (PCM) framework, a Joint Maximum Likelihood Estimate (JMLE) can be performed and the estimation preferably represented in the form of log-odds units, using the following equation:

$$Log ( \frac{{P}_{niqj}}{{P}_{niq ( j - 1 )}} ) = ( \begin{matrix}{D}_{i} - {R}_{q} - {F}_{j} & if PCM with Raters \\ {D}_{i} - {F}_{j} & if PCM without raters\end{matrix} )$$

### Where:

P_{niqj} is the probability of observing category ‘j’ when rater ‘q’ responds to item ‘i’ for person
P_{niq(j-1)} is the probability of observing category ‘j-1’ when rater ‘q’ responds to item ‘i’ for person ‘n’;
Dᵢ is the location of item ‘i’;
R_{q} is the location of rater ‘q’;
Fⱼ is Rasch-Andrich threshold, the point of equal probability on the latent variable between categories ‘j’ and ‘j-1’.

Further, at step 108, as an alternative to aggregating all the data types (of the corresponding MASI variables) into the PCM framework, a facet model which selects an appropriate Multi-Facet Rasch Model (MFRM) based on the data type of each of the MASI variables is utilized to compute the Bayesian Joint Maximum Likelihood Estimate (B-JMLE). In this exemplary embodiment, depending upon at least the data type of the corresponding (MASI) data variables, a multi-facet Rasch model is selected (from a Rasch family of models). A selected model is implemented only if it considered appropriate for the underlying data type. It would be obvious to one skilled in the art that the present disclosure is not restricted to Rasch family of models alone, which are used as an illustrative embodiment to exemplify the features envisioned by the present disclosure. It is also within the scope of the present disclosure to replace the Rasch family of model with any other appropriate psychometric models provided the data types suit the longstanding requirements of objective measurement.

Further at step 108, the Bayesian Joint Maximum Likelihood Estimate (B-JMLE) is computed and is preferably represented in terms of log odds unit estimates (logits) using the below mentioned meta-equations (representative of Rasch family of models). The meta equations are executed only if they are deemed appropriate for the underlying data variables. The meta-equations are represented as follows:

$$Log ( \frac{{P}_{niqj}}{{P}_{niq ( j - 1 )}} ) = \{ \begin{matrix}{B}_{n} - ( \begin{matrix}{D}_{i} - {R}_{q} - {F}_{j} & if PCM with Raters \\ {D}_{i} - {F}_{j} & if PCM without raters \\ {D}_{i} - log ( x ) where x = 1 , ∞ & if Poisson counts \\ {D}_{i} - log ( x / m - x + 1 ) where x = 1 , m & if Binomial trial\end{matrix} ) \\ - log ( 1 + {e}^{( Bn - Di )} ) + log ( x - 1 / x - m ) if Inverse Binomial \\ - log ( 1 + {e}^{( Di - Bn )} ) + log ( x - 1 / x - m ) if Mirror Inverse Binomial \\ [ Any Other Rasch Model ]\end{matrix} \}$$

P_{niqj} is the probability of observing category ‘j’ when rater ‘q’ responds to item ‘i’ for person ‘n’;
P_{niq(j-1)} is the probability of observing category ‘j-1’ when rater ‘q’ responds to item ‘i’ for person ‘n’;
Dᵢ is the location of item ‘i’;
Bₙ is the measure of person ‘n’;
R_{q} is the location of rater ‘q’;
Fⱼ Rasch-Andrich threshold, the point of equal probability on the latent variable between categories ‘j’ and ‘j-1’;
X is the raw data;
and M is the trial number.

TABLE 3
Example Constructs, Scoring Rubrics and Appropriate Rasch Models

| | | Example Data | Illustrative constructs and scoring |
|---|---|---|---|
| Rasch Model | Raw Data Type | Collection Sources | Rubrics |
| Poisson | Counts within a | Smartphone | Conscientiousness: #time battery <10% |
| Counts | fixed period of | metadata, | in one week: |
| | time | accelerometer, | Intelligence: #seconds response latency; |
| | | Twitter and | Persuasion: # retweets in a month; |
| | | Facebook API, | Conscientiousness: # songs liked in |
| | | Holter | ‘rebellious’ genre; |
| | | electrocardiogram, | Team Effectiveness: # speaking turns in |
| | | songs liked | 1 Hour meeting; |
| | | | Narcissism: # selfies posted in last 6 |
| | | | months. |
| Binomial | Counts (x) in (m) | Deep Learning | Charisma: # metaphors used in 10 blog |
| | attempts | API, GPS, | posts; |
| | | Accelerometer, | Athlete Performance: # baskets in 10 |
| | | Gyrometer | tries; |
| | | | Quality of Life: # times the standard |
| | | | deviation of time in bed between nights |
| | | | >1.96; |
| | | | Happiness: # times GPS in natural |
| | | | environment in a month. |
| Inverse | Counts (x) | GPS + Chronometer, | Fire Fighter Performance: # minutes to |
| Binomial | required to | bag-of-visual | arrive on-site; # minutes to enter a |
| | achieve a | words video | building; # attempts before one basket is |
| | successful target | | made |
| | value (m) | | |
| Mirror | Counts (x) | Audio sampling, | Team Coordination: # seconds until |
| Binomial | required to | missing data in | speaker in interrupted once; |
| | achieve (m) | journals, missed | Performance: # products produced until |
| | failures | call log in mobile | one defective piece is found; |
| | | phone | Stress: # calls received until missed; |
| | | | Conscientiousness: # days until person |
| | | | neglects to journal per schedule; |
| Dichotomous | Binary | Mobile data | Conscientiousness: installed LinkedIn |
| | | scraping | application; |
| | | application; | Conscientiousness: battery never falling |
| | | Smartphone meta | below 10%. |
| | | data | |

In accordance with the present disclosure, preferably, the item bank constituting the ‘gold standard’ are anchored, and a fuzzy polytomous Joint Maximum Likelihood Estimation is performed on the remaining data variables (typically, the MASI variables), hi this manner, the MASI variables are analyzed and processed in the same qualitative framework as that of the data items constituting the ‘gold standard’ data item bank. The fuzzy, polytomous Joint Maximum Likelihood Estimation is iteratively performed for every combination of MASI data variables and the data items constituting the ‘gold standard’ data item bank, using each of the Rasch models selected from the Rasch family. The following equations illustrate the fuzzy, polytomous Joint Maximum Likelihood Estimation for conventional Computer Adaptive tests:

$${B}_{m} + 1 = {B}_{m} + {R}_{m} - \frac{{\sum }^{ } {P}_{mi}}{{\sum }^{ } {P}_{mi} ( 1 - {P}_{mi} )} ( i = 1 to m )$$

$${SE}_{m + 1} = √ 1 / {\sum }^{ } {P}_{mi} ( 1 - {P}_{mi} ) ( i = 1 to m )$$

Where ‘B’ is the estimate of person location, ‘R’ is the response for each Rasch model, ‘P’ is the probability estimate for the corresponding Rasch model, and ‘SE’ is the Standard Error.

It would be obvious to one skilled in the art that the present disclosure is not restricted to traditional Computer Aided Tests (CAT) which is used as an illustrative embodiment to exemplify the features envisaged by the present disclosure. It is also within the scope of the present disclosure to replace the traditional CAT with Bayesian Computer Adaptive methods.

In accordance with the present disclosure, while the preferred Joint Maximum Likelihood Estimation is repeated for every combination of data items constituting the ‘gold standard’ data item hank and the MASI data variables and for each of the Rasch models, the quality statistics indicative of the degree to which the estimations satisfy the Rasch quality parameters are simultaneously determined. The quality statistics include but are not restricted to inlier weighted fit statistics, outlier weighted fit statistics, and point-measure correlations. Preferably, the quality statistics are computed for each of the Rasch models, and for multiple combinations of MASI variables and data types constituting the ‘gold standard’ data item bank, thereby ensuring strict quality control for MAST variables considered relevant for constructing metrological instruments.

At step 110, the log odds unit estimates and the corresponding quality statistics are stored in a repository. Subsequently, at step 112, based on a comparison of the log odds unit estimates, at least one combination of data items (MASI data variables and data items constituting the gold standard data item bank) relevant for constructing an insightful metrological instrument/measurement is determined.

In accordance with the present disclosure, a plurality of combinations of data items are evaluated across the Rasch family of models for adherence to Rasch quality control parameters including but not restricted to inlier weighted tit statistics, outlier weighted fit statistics, and point-measure correlations. The method envisaged by the present disclosure enables an analyst to specify the target values for the aforementioned control parameters as well as calibrate the upper and lower level tolerances corresponding to the control parameters.

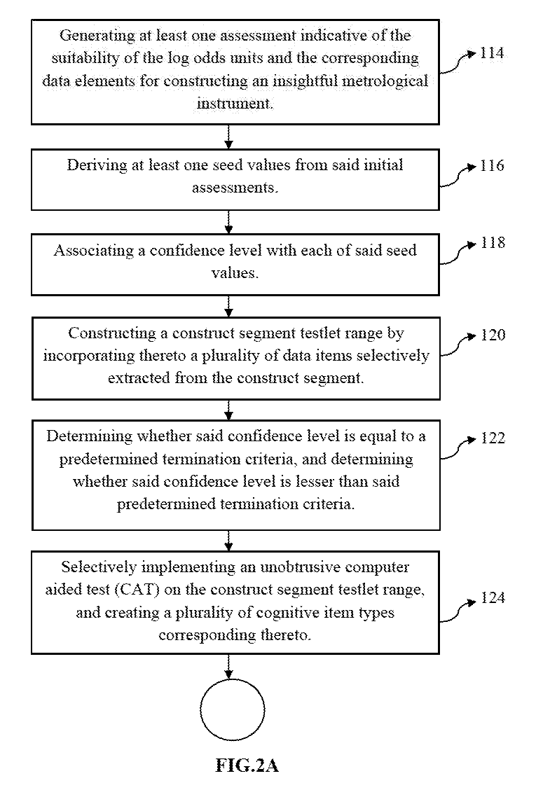

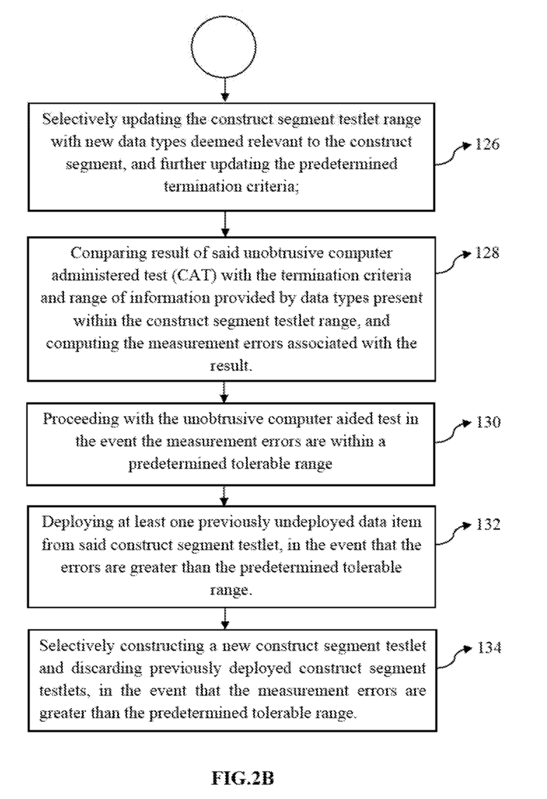

Referring to FIG. 2A and FIG. 2B in combination, the method envisaged by the present disclosure further includes generating at least one assessment indicative of the suitability of the log odds unit estimates and the corresponding data items for constructing an insightful metrological instrument (step 114). Further, a user (preferably an analyst) is prompted (via a graphical user interface) to specify a goal. For example, a goal could involve measuring personality traits such as conscientiousness, intelligence, and persuasion. Subsequent to goal setting, if the log odds unit estimates and the corresponding data elements are deemed to be sufficient for goal assessment, then the assessment procedure is implemented using the metrological instrument (created at step 114) the user is preferably provided natural language feedback via the graphical user interface in respect of the goal assessment.

However, when the combination of data items (generated at step 112) are determined to be insufficient, i.e., if they are determined to produce partial, insufficient information, then at step 116, such a combination of data items is considered as a ‘seed value’ and used as a pointer to capture any other relevant information. At step 116, at least one seed value is selectively determined from the combination of data items generated at step 112. At step 118, a confidence level is attached to the seed value. The confidence level is indicative of the relevance of seeds values to a predetermined latent trait (construct segment) that needs to be assessed. At step 120, a construct segment testlet range (a testlet refers to a collection of data items based on a single stimulus, the stimulus for example being a reading comprehension test) is constructed by extracting data items and data types (preferably from the data items generated at step 112) deemed relevant to the construct segment. At step 122, it is determined whether the confidence level attached to the seed value equal to a predetermined termination criterion. For example, the termination criteria could specify that an error rate not more than 0.1% is allowable for results calculated using the seed value. Further at step 124, it is also determined whether the confidence level attached to each of the seed values (in case of availability of multiple seed values) is respectively lesser than the predetermined termination criteria. In the event that the confidence level of the seed values are lesser than or equal to the termination criteria, then the method is terminated. Otherwise, at step 126, an unobtrusive Computer Aided Test (CAT) is administered on the construct segment testlet range, and a plurality of cognitive item types including but not restricted to movement time (MT), reaction time (RT), difference between consecutive trials, error rate and standard deviation (SD). At step 128, the cognitive item types (including SD, MT, RT, error rate) are compared with the termination criteria followed by an analysis of the data elements and the corresponding data types present within the construct segment testlet range. At step 130, based on the comparison, if the cognitive item type values fall within the limits of the termination criteria, then the unobtrusive CAT is iteratively implemented. Otherwise, if the cognitive item type values do not fall within the limits of the termination criteria, but there are other data elements in the construct segment testlet range available for deployment, then such data elements are deployed (at step 132) and the steps 116 to 130 are repeated and new cognitive item type values are generated. However, if the new cognitive item type values also do not fall within the limits of the termination criteria and if there are no more data elements available in the construct segment testlet range, then at step 134 the next construct segment closest to the assessment generated in step 114 is selected for analysis.

The present disclosure envisages utilizing two-stage and three-stage artificially intelligent Rasch raters to process and accordingly rate the raw data. The two-stage and three-stage artificially intelligent Rasch raters typically make use of the raw data that has been preferably processed using a set of deep learning procedures/framework. When the raw data is processed using the deep learning framework, a set of multi source ratings are attached to the raw data. The multi source ratings are preferably obtained from predetermined experts whose measurements are considered a close approximation of the Rasch models and Rasch quality control standards. The deep learning framework firstly categorizes the raw data as being relevant to a context of interest as well as being irrelevant to the context of interest. Secondly, the deep learning framework attaches the multi source ratings to each of the data categories created by the deep learning framework.

Preferably, the raw data (for example, textual data and video samples) is processed by the deep learning framework at a predetermined frequency, for example, daily, weekly, fortnightly (the frequency of processing is typically decided by an analyst), and subsequently, the processed data is classified based on the relevance (of the processed data) to at least one dimension which is to be measured (for example, ‘team effectiveness’ or ‘persuasion’) and any corresponding sub-facets of the dimension to be measured. Further, at a second stage, the data is again classified into appropriate scales with Rasch-Andrich thresholds which are based on Rasch quality control standards (illustrated in Table 1) including but not restricted inlier-weighted misfit and outlier weighted misfit. Subsequently, the classified raw data is processed with Joint Maximum Likelihood Estimation (JMLE) techniques and a plurality of log-odds units are generated, which in turn would be used to construct a metrological instrument (as described in FIG. 1). In case of a three-stage artificially intelligent Rasch rater, the first and the second stage are same as that of the two-stage artificially intelligent Rasch rater, and at a third stage, the log-odds units are stored and subsequently compared with any available historic data, before the construction of the metrological measurement.

### Technical Advantages

The technical advantages envisaged by the present disclosure include the realization of a method that automatically collects relevant data from user devices (for example, mobile phones) in the least obtrusive manner possible, and provides an opportunity to analyze a user's latent trait (for example, user personality) also in the least obtrusive manner possible. The said method envisages extracting data from user devices since they are deemed to be the most frequently used devices holding all the data necessary to reasonably interpret the personality of the device user. The method further envisages auditing the extracted data and compares the extracted data with predetermined, pre-calibrated data item types. In fact the data is also extracted from the user devices based on the relevance to the pre-calibrated data item types. The method further envisages using the raw data together with an inverted Computer Adaptive Measurement System (iCAM) to compute a plurality of relevant dimensions. Further, the method envisages providing information about the location of each attribute and measurement error. The attributes are analyzed using fuzzy logic and the location of each of the attributes is highlighted in predetermined color codes depending at least upon the corresponding measurement error. The said method further highlights any dimensions that are insufficiently precise. Further, the said method makes use of fuzzy logic and influential text to report whether additional measurements are necessary to gain sufficient precision on all the dimensions.

Further, the method envisaged by the present disclosure allows the users to choose their preferred metrological approach without sacrificing on the metrological information and without having to take into consideration the drawbacks associated with the traditional lexical measurement schemes. Further, since the pre-calibrated data item types are adaptive to diversified scoring methodologies including the ones corresponding to lexical, physical (gyrometer, accelerometer), auditory (prosody), video and social network (Bluetooth, SMS, Facebook), any metrological process implemented using the pre-calibrated data item types would portray a meaningful approximation of the diversified dimensions intended to be measured. Further, the said method envisages using any available previous behavior sampling estimates as the seed values to the dimensions which wire required to be approximated, thereby ensuring that the precision associated with the process of dimension approximation, and that the previously generated information is also not underutilized. The said method further interprets any change information based on the positioning of the measured dimensions and (any) corresponding measurement errors, and accordingly generates relevant recommendations aimed at mitigating the measurement errors during subsequent iterations. Further, the method envisaged by the present disclosure makes use of sufficient quality control standards to ensure an objective assessment of the dimensions underlying the raw data. By connecting the qualitative meaning of the data items with the quantitative values, the method ensures metrological and theoretical traceability. Further, the said method analyzes hypothetical and theoretical raw data in the same frame of reference as that of pre-calibrated data item types thereby ensuring that all the data items used in the process of constructing a metrological instrument are validate under the same frame of reference, and that the data used for construction of the metrological instrument remains consistent in terms of quality.

Further, the said method envisages synthesizing a diverse set of raw data inputs and combining them into a metrological instrument which imposes confidence in terms of identification and analysis of latent constructs and minimizes the occurrence of errors. Further, the said method envisages a hybridized combination of Single attempt Multiple Item (SAMI) type and Multiple Attempt Single Item (MASI) type data variables to be used in a metrological instrument.

The foregoing description discloses the general nature of the embodiments that others can, by applying current knowledge, readily modify and/or adapt for various applications without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, those skilled in the art will recognize that the embodiments herein can be practiced with several suitable modifications without departing from the scope of the claims.

What is claimed is:

1. A computer implemented method for constructing a metrological instrument, said method comprising the following computer implemented steps:
creating a pre-calibrated data item bank comprising data elements relevant to at least one psychometric/metrological domain, said data elements measuring at least one predetermined unidimensional attribute, and calibrating said data elements using at least one predetermined gold standard framework;
identifying raw data corresponding to said psychometric domain, said raw data deemed as an addendum to the data incorporated into said pre-calibrated data item bank, and specifying at least one scoring rubric for analysis of identified raw data; analyzing the raw data based on said scoring rubric, and selectively adding predetermined notations to at least a part of the identified raw data, during analysis thereof;
identifying from the raw data, at least data elements incorporating, data variables relevant to said predetermined unidimensional attribute;
identifying at least data type of each data variable incorporated in the data elements corresponding to the raw data, and in the data elements analyzed using said gold standard framework, and identifying, at least partially based on the data type, at least one metrological model suitable for analysis of data elements corresponding to the raw data and the data elements analyzed using said gold standard framework;
selectively combining each of the data elements identified from the raw data with each of the data elements analyzed using said predetermined gold standard framework, and generating a plurality of data element combinations, and iteratively calculating log-odds unit estimates corresponding to said data element combinations, using a plurality of Rasch Models;
storing said log-odds unit estimates in a repository;
identifying, based at least partially on said log-odds unit estimates, at least one combination of data elements fulfilling a plurality of predetermined Rasch quality control parameters, and constructing a metrological measurement instrument based on identified combination of data elements.

2. The method as claimed in claim 1, wherein the step of identifying raw data corresponding to said psychometric domain, further includes the following steps:
categorizing the raw data into a plurality of categories based on degree of resolution associated with each category of raw data;
representing each of the categories as incorporating raw data having a predetermined degree of resolution;
selectively calibrating the degree of resolution corresponding to at least one of the categories; and
identifying at least one Multiple Attempt Single Item (MASI) variable corresponding to each of the categories.

3. The method as claimed in claim 1, wherein the step of selectively adding predetermined notations to at least a part of the identified raw data, further includes the step of adding predetermined tags signifying the relevance of the identified raw data to the corresponding metrological domain.

4. The method as claimed in claim 1, wherein the step of analyzing the raw data based on said scoring rubric, further includes the step of analyzing the raw data based on a plurality of predetermined levels of data resolution.

5. The method as claimed in claim 1, wherein the step of analyzing the raw data based on said scoring rubric, thither includes the step of classifying the raw data into a plurality of predetermined categories, and rating each of said predetermined categories based on at least one of an artificially intelligent Rasch rater and Many Facet Rasch Measurement (MFRM) framework.

6. The method as claimed in claim 1, wherein the step of identifying the raw data corresponding to the psychometric domain further includes the step of capturing data corresponding to cognitive ability of a user, said step of capturing data corresponding to cognitive ability of a user, further including the following steps:
displaying a predetermined reaction stimuli to a user, and prompting said user to perform at least on predetermined action in response to the display of said reaction stimuli; and
measuring at least one of cognitive ability, psychomotor ability, learning construct and rating construct of the user.

7. The method as claimed in claim 1, wherein the method further includes the following steps:
detecting patterns in the raw data;
categorizing said patterns based on relevance of said raw data to a construct of interest and assigning predetermined-multi source ratings to each of said patterns;
comparing the multi-source ratings with predetermined threshold values, and determining whether the multi-source ratings are accurate; and
classifying said raw data into a predetermined scale based on a Rasch-Andrich threshold, said Rasch-Andrich threshold derived from said gold standard framework.

8. The method as claimed in claim 1, wherein the method further includes the step of generating a report identifying at least attributes corresponding to the data elements relevant for the optimal transdisciplinary metrology, and specifying measurement errors associated with measurement of each of said attributes.

9. The method as claimed in claim 1, wherein the step of identifying raw data corresponding to said psychometric domain, further includes the step of selecting a distribution pattern corresponding to the raw data and the scoring rubric, and identifying from the distribution pattern, a plurality of pointers to be used as inputs for said scoring rubric.

10. The method as claimed in claim 1, wherein the step of selecting at least one of the Rasch models from a Rasch model family, further includes the step of selecting from the Rasch model family at least one of a Rasch Partial Credit model, Rating Scale model, Poisson Counts model, Rasch Binomial model, Rasch Inverse Binomial model, Rasch Mirror Binomial model, and Dichotomous model.

11. The method as claimed in claim 1, wherein the step of computing log-odds units, further includes the step of computing the log-odds units using at least one of a Joint Maximum Likelihood Estimation (JMLE) procedure, Marginal Maximum Likelihood Estimation (MMLE) procedure, and Bayesian Maximum Likelihood Estimation (BMLE) procedure.

12. The method as claimed in claim 1, wherein the step of identifying at least one combination of data elements fulfilling a plurality of predetermined Rasch quality control parameters, further includes the step of identifying at least one combination of data elements fulfilling Rasch quality control parameters selected from the group consisting of inlier weighted fit statistics, infit outlier weighted fit statistics, outfit outlier weighted fit statistics, and point measure correlations.

13. The method as claimed in claim 1, wherein the step of creating a pre-calibrated data item bank, further includes the step of calibrating the data elements of the data item bank using the gold standard framework selected from a group consisting of a Partial Credit Model (PCM) and Rasch Measurement Standards.

14. The method as claimed in claim 1, wherein the method further includes the following steps:
displaying at least an initial assessment generated as a result of said predetermined psychometric measurements being performed on the identified combination data elements, on a graphical user interface accessible to a user;
prompting said user to set at least one goal, and further prompting said user to selectively choose at least one pre-calibrated assessment procedure for assessing at least said identified combination data elements; and
tracking at least activities performed by said user, in respect of said pre-calibrated assessment procedure and providing a natural language feedback to the user.

15. The method as claimed in claim 14, wherein the method further includes the following steps:
deriving at least one seed value from said initial assessment corresponding to said predetermined psychometric measurements;
associating a confidence level with each of said seed values, wherein said confidence level is indicative of at least relevance of said seed values to a predetermined construct segment;
constructing a construct segment testlet range by incorporating thereto a plurality of data items selectively extracted from the construct segment, based on the relevance of the data items and data types, to the construct segment;
determining whether said confidence level corresponding to each of said seed values is equal to a predetermined termination criteria, and further determining whether said confidence level corresponding to each of said seed values is lesser than said predetermined termination criteria;
selectively implementing an unobtrusive computer aided test (CAT) on the construct segment testlet range, and creating a plurality of cognitive item types corresponding thereto, said cognitive item types selected from the group consisting of movement time (MT), reaction time (RT), difference between consecutive trials, standard deviation (SD) between MT and RT, and errors;
selectively updating the construct segment testlet range with new data types deemed relevant to the construct segment, and further updating the predetermined termination criteria;
comparing result of said unobtrusive computer administered test (CAT) with the termination criteria and range of information provided by data types present within the construct segment testlet range, and computing at least measurement errors associated with the result, based on comparison;
proceeding with the unobtrusive computer aided test in the event the errors are within a predetermined tolerable range;
deploying at least one previously undeployed data item from said construct segment testlet, in the event that the errors are greater than the predetermined tolerable range; and
selectively constructing a new construct segment testlet and discarding previously deployed construct segment testlets in the event that the measurement errors are greater than the predetermined tolerable range.
